(19) United States
(12) Patent Application Publication
(10) Pub. No.: US 2020/0370533 A1
(43) Pub. Date: Nov. 26, 2020

(54) BLADE PROTECTION MEMBER, AND WIND TURBINE BLADE AND WIND TURBINE USING SAME

(71) Applicant: INSTITUTE OF NUCLEAR ENERGY RESEARCH, ATOMIC ENERGY COUNCIL, EXECUTIVE YUAN, R.O.C., Taoyuan City (TW)

(72) Inventor: YAN-TING LIN, TAOYUAN CITY (TW)

(21) Appl. No.: 16/548,908

(22) Filed: Aug. 23, 2019

(30) Foreign Application Priority Data
May 22, 2019 (TW) 108117763

(51) Int. Cl. F03D 1/06; F03D 80/00

(52) U.S. Cl. CPC F03D 1/0675; F05B 2280/5011; F05B 2280/6001; F03D 80/00

(57) ABSTRACT

A blade protection member includes an adhesive layer, an opaque flexible layer and a porous vortex-suppressing layer. The opaque flexible layer covers the adhesive layer. The porous vortex-suppressing layer covers the opaque flexible layer, is exposed, and has a porous structure for passage of airflow and absorption of airflow. The blade protection member reinforces the trailing edge of the wind turbine blade, absorbs and eliminates vortex, reduces wake turbulence strength, and reduces aerodynamic noise during operation. A wind turbine blade and a wind turbine which have the blade protection member each are further introduced.

### CROSS-REFERENCE TO RELATED APPLICATION

This non-provisional application claims priority under 35 U.S.C. § 119(a) on Patent Application No(s). 108117763 filed in Taiwan, R.O.C. on May 22, 2019, the entire contents of which are hereby incorporated by reference.

### BACKGROUND OF THE INVENTION

### 1. Field of the Invention

The present disclosure relates to a blade protection member, and a wind turbine blade and a wind turbine using the same, and in particular to a blade protection member capable of reducing blade surface stress fatigue, and a wind turbine blade and a wind turbine using the same.

### 2. Description of the Related Art

For the sake of green energy, offshore wind power has great potential for gradual replacement of nuclear power. However, as shown in FIG. 1A, the difference in pressure between the upper and lower sides of a wind turbine blade D causes additional burden to be imposed on the wind turbine blade D and leads to cracks and further enlargement thereof at a thin trailing edge D1 of the wind turbine blade D to the detriment of the blade structure. Furthermore, the trailing edge D1 is susceptible to vortex which causes wake turbulence and aerodynamic noise.

Referring to FIG. 1B, the wind turbine blade D is often hit by dust, salt particles and foreign bodies and exposed to rainfall and ultraviolet. As a result, the wind turbine blade D degenerates, forms fatigue-induced cracks, and in consequence the wind turbine ends up with reduced reliability, shortened service life and elevated maintenance cost.

To protect the wind turbine blades, manufacturers mount a protection device on the blade. However, the protection device is usually solid hardware and thus requires die-opening manufacturing but cannot be widely used in various wind turbine blades. Furthermore, its protection effect is so little that it fails to provide full protection against every type of damage.

### BRIEF SUMMARY OF THE INVENTION

In view of the aforesaid drawbacks of the prior art, an objective of the present disclosure is to provide a blade protection member.

To achieve at least the above objective, the present disclosure provides a blade protection member for enclosing a trailing edge of a wind turbine blade, comprising: an adhesive layer adhering to the trailing edge of the wind turbine blade; an opaque flexible layer covering the adhesive layer; and a porous vortex-suppressing layer covering the opaque flexible layer, exposed to an outside, and having a porous structure for passage of airflow and absorption of airflow.

In an embodiment of the present disclosure, the surface of the porous vortex-suppressing layer is fluffy.

In an embodiment of the present disclosure, the surface of the porous vortex-suppressing layer is a beard-shaped surface.

In an embodiment of the present disclosure, the surface of the porous vortex-suppressing layer is made of non-woven fabric.

In an embodiment of the present disclosure, the opaque flexible layer is made of weather-fastness opaque resilient material.

In an embodiment of the present disclosure, the adhesive layer is made of weather-fastness resilient adhesive.

The present disclosure further provides a wind turbine blade comprising: a body; and the blade protection member enclosing two sides of a trailing edge of the body.

The present disclosure further provides a wind turbine comprising: a rotating shaft; and a plurality of said wind turbine blades with root portions connected to the rotating shaft.

Therefore, according to the present disclosure, the opaque flexible layer and the adhesive layer reinforce the trailing edge of the wind turbine blade to thereby resist the strength of repeated actions of wake turbulence and aerodynamic force. The porous structure of the porous vortex-suppressing layer absorbs and eliminates the vortex on the wind turbine blade surface and reduces wake turbulence strength. Furthermore, the aforesaid absorption of airflow and the mechanism of friction between the surface of the porous vortex-suppressing layer and airflow together reduce the aerodynamic noise of the wind turbine in operation, so as to reduce the effect of the wind turbine on the surroundings. Hence, the strength of the anti-loading of the wind turbine blade is effectively enhanced. Furthermore, both the pressure load on the surface of the wind turbine upon escape of airflow and the load arising from the difference in pressure between the upper and lower sides of the wind turbine blade are also reduced. This prevents cracks from happening to the trailing edge of the wind turbine blade to the detriment of overall structure. Therefore, the wind turbine blade uses the blade protection member to effectively and widely resist various ambient damage and reduce noise pollution.

According to the present disclosure, the blade protection member is applicable to various wind turbines and wind turbine blades. Furthermore, the installation and replacement of the blade protection member are easy. The blade protection member can be directly mounted on a new wind turbine or an old wind turbine to mitigate the degeneration of the wind turbine blade and augment the wide applications thereof.

### BRIEF DESCRIPTION OF THE DRAWINGS

FIG. 1A (PRIOR ART) is a cross-sectional schematic view of a conventional wind turbine blade.

FIG. 1B (PRIOR ART) is another cross-sectional schematic view of a conventional wind turbine blade.

FIG. 2 is a perspective schematic view of a wind turbine with a blade protection member according to an embodiment of the present disclosure.

FIG. 3 is a cross-sectional schematic view of a wind turbine blade with the blade protection member according to an embodiment of the present disclosure.

FIG. 4 is a cross-sectional schematic view of the wind turbine blade according to an embodiment of the present disclosure.

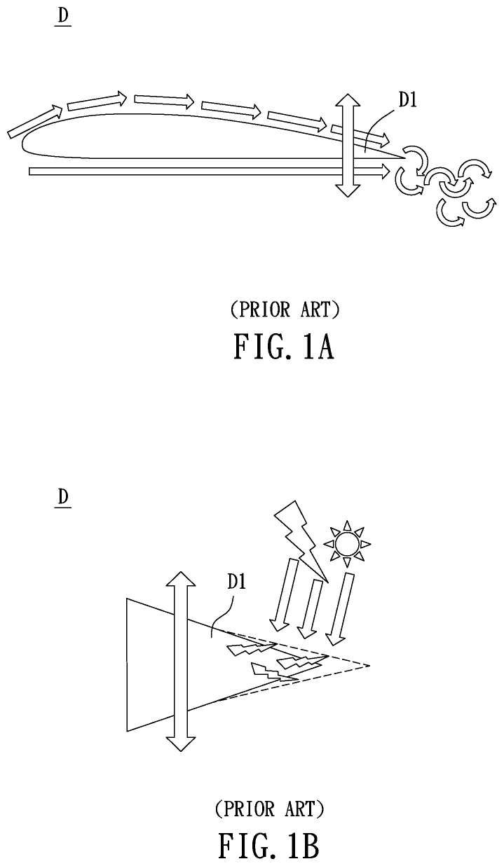

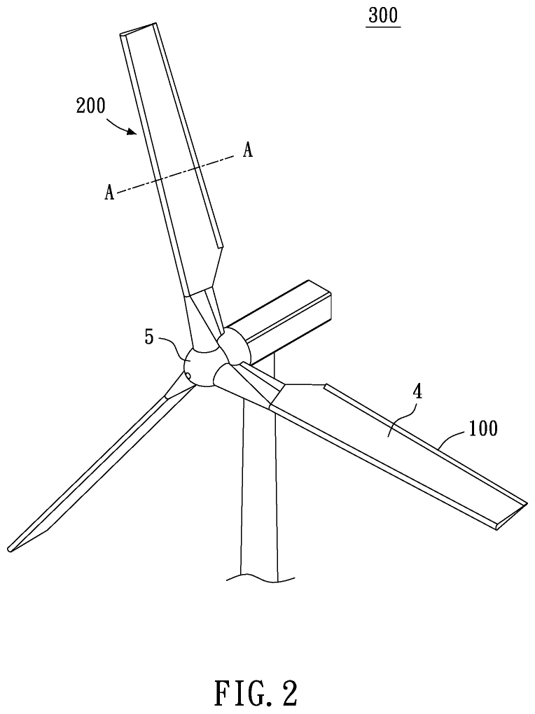

### DETAILED DESCRIPTION OF THE INVETION

To facilitate understanding of the object, characteristics and effects of this present disclosure, embodiments together with the attached drawings for the detailed description of the present disclosure are provided. The present disclosure is implemented or applied by other different, specific embodiments. Various modifications and changes can be made in accordance with different viewpoints and applications to details disclosed herein without departing from the spirit of the present disclosure. Technical features of the present disclosure are illustrated by embodiments and described below, but the embodiments are not restrictive of the claims of the present disclosure.

Referring to FIG. 2, a wind turbine 300 with a blade protection member 100 according to an embodiment of the present disclosure comprises a rotating shaft 5 and a plurality of wind turbine blades 200. Root portions of the wind turbine blades 200 are connected to the rotating shaft 5.

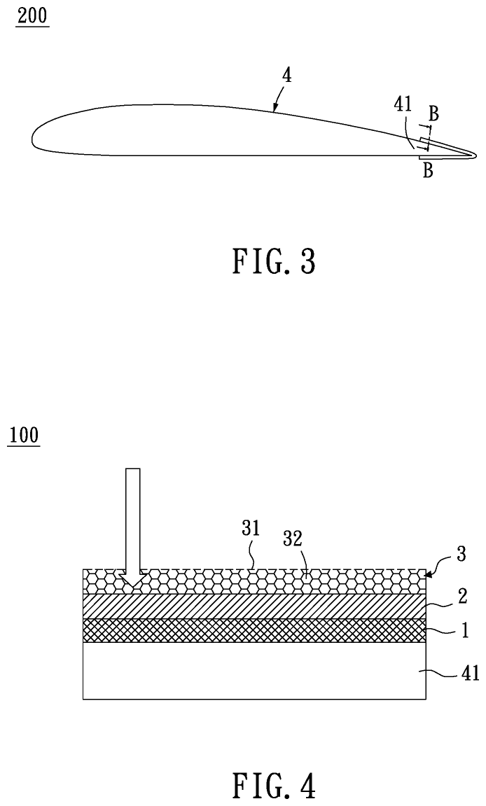

Referring to FIG. 2 and FIG. 3, FIG. 3 is a cross-sectional schematic view, taken along line A-A of FIG. 2, of a wind turbine blade with the blade protection member according to an embodiment of the present disclosure. Each wind turbine blade 200 comprises a body 4 and a blade protection member 100 enclosing the two sides of the trailing edge 41 of the body 4 of the wind turbine blade 200.

FIG. 4 is a cross-sectional view taken along line B-B of FIG. 3. Referring to FIG. 4, the blade protection member 100 comprises an adhesive layer 1, an opaque flexible layer 2 and a porous vortex-suppressing layer 3.

The adhesive layer 1 is adhered to the trailing edge 41 of the wind turbine blade 200 and disposed between the trailing edge 41 and the opaque flexible layer 2.

The opaque flexible layer 2 covers the adhesive layer 1. With the adhesive layer 1 being adhesive, the opaque flexible layer 2 is attached to the two sides of the trailing edge 41 through the adhesive layer 1. The opaque flexible layer 2 is, for example, made of resilient wiring, resilient composite fiber, resilient coating or resilient block, and can block hazardous electromagnetic wave, such as ultraviolet.

The porous vortex-suppressing layer 3 is the outermost layer of the blade protection member 100 and covers the opaque flexible layer 2. The surface 31 of the porous vortex-suppressing layer 3 is exposed and has a porous structure 32 for passage of airflow (as indicated by the arrow in FIG. 4) and absorption of airflow, thereby suppressing tail vortex.

According to the present disclosure, the opaque flexible layer 2 and the adhesive layer 1 reinforce the trailing edge 41 of the wind turbine blade 200 and resist the strength of repeated actions of wake turbulence and aerodynamic force. The porous structure 32 of the porous vortex-suppressing layer 3 absorbs and eliminates the vortex on the surface of the wind turbine blade 200 and reduces wake turbulence strength. Furthermore, the aforesaid absorption of airflow and the mechanism of friction between the surface 31 of the porous vortex-suppressing layer 3 and airflow together reduce the aerodynamic noise of the wind turbine 300 in operation, so as to reduce the effect of the wind turbine 300 on the surroundings.

Hence, the strength of the anti-loading of the wind turbine blade 200 is effectively enhanced. Furthermore, both the pressure load on the surface of the wind turbine 300 upon escape of airflow and the load arising from the difference in pressure between the upper and lower sides of the wind turbine blade 200 are also reduced. This prevents cracks from happening to the trailing edge 41 of the wind turbine blade 200 to the detriment of overall structure. Therefore, the wind turbine blade 200 uses the blade protection member 100 to effectively and widely resist various ambient damage and reduce noise pollution.

According to the present disclosure, the blade protection member 100 is applicable to various wind turbines and wind turbine blades. Furthermore, installation and replacement of the blade protection member 100 are easy. The blade protection member 100 is directly mounted on a new wind turbine or an old wind turbine to mitigate the degeneration of the wind turbine blade and augment the wide applications thereof.

Furthermore, in an embodiment, the surface 31 of the porous vortex-suppressing layer 3 is fluffy.

Furthermore, in an embodiment, the surface 31 of the porous vortex-suppressing layer 3 is a beard-shaped surface.

Furthermore, in an embodiment, the surface 31 of the porous vortex-suppressing layer 3 is made of non-woven fabric.

The porous vortex-suppressing layer 3 is made of flexible, soft, porous material, and its edge is serrate, wavy, linear, curved, etc., as appropriate to meet the requirement of the wind turbine blade 200.

Furthermore, in an embodiment, the opaque flexible layer 2 is made of a weather-fastness, opaque, resilient material, so as to be resistant to extreme temperatures, block bright light, and is moisture-proof, for example, weather-fastness rubber, thermoplastic elastomer (TPE), or automotive coating.

Furthermore, in an embodiment, the adhesive layer 1 is made of weather-fastness, resilient adhesive, for example, water-based acrylic resilient waterproof adhesive, pull-resistant composite carbon fiber, silicon resilient adhesive, or polyurethane acrylate. Hence, the blade protection member not only weathers adverse environments but is also not predisposed to degeneration.

While the present disclosure has been described by means of specific embodiments, numerous modifications and variations could be made thereto by those skilled in the art without departing from the scope and spirit of the present disclosure set forth in the claims.

What is claimed is:

1. A blade protection member for enclosing a trailing edge of a wind turbine blade, comprising:
an adhesive layer adhering to the trailing edge of the wind turbine blade;
an opaque flexible layer covering the adhesive layer; and
a porous vortex-suppressing layer covering the opaque flexible layer, exposed to an outside, and having a porous structure for passage of airflow and absorption of airflow.

2. The blade protection member of claim 1, wherein a surface of the porous vortex-suppressing layer is fluffy.

3. The blade protection member of claim 1, wherein a surface of the porous vortex-suppressing layer is a beard-shaped surface.

4. The blade protection member of claim 1, wherein a surface of the porous vortex-suppressing layer is made of non-woven fabric.

5. The blade protection member of claim 1, wherein the opaque flexible layer is made of weather-fastness, opaque, resilient material.

6. The blade protection member of claim 1, wherein the adhesive layer is made of weather-fastness, resilient adhesive.

7. A wind turbine blade, comprising:
a body; and
the blade protection member of claim 1, the blade protection member enclosing two sides of a trailing edge of the body.

8. A wind turbine, comprising:
a rotating shaft; and
a plurality of wind turbine blades of claim 7, the wind turbine blades having root portions connected to the rotating shaft.
